(19) United States
(12) Patent Application Publication
(10) Pub. No.: US 2020/0355830 A1
(43) Pub. Date: Nov. 12, 2020

(54) SAFEGUARDING THE SURROUNDING AREA OF A VEHICLE

(71) Applicant: SICK AG, Waldkirch (DE)

(72) Inventors: Thomas MISSBACH, Waldkirch (DE); Jonas RIST, Waldkirch (DE); Christian MATT, Waldkirch (DE)

(21) Appl. No.: 16/867,016

(22) Filed: May 5, 2020

(30) Foreign Application Priority Data
May 6, 2019 (DE) 102019111642.2

(51) Int. Cl. G01S 17/931; G01S 17/86; G05D 1/00; G01S 7/481

(52) U.S. Cl. CPC G01S 17/931; G01S 7/4817; G05D 1/0088; G01S 17/86

(57) ABSTRACT

A safety system (10, 64) for safeguarding the surrounding area of a vehicle (50), wherein the safety system (10, 64) comprises an optoelectronic safety sensor (10) for monitoring the surrounding area, a first input (40) connectable to a first kinematic sensor (56) for determining a first speed value for the speed of the vehicle (50), and a control and evaluation unit (34, 64) configured to detect objects in the surrounding area based on sensor data of the optoelectronic safety sensor (10) and to evaluate whether or not the vehicle (50) initiates a safety reaction, taking into account the speed of the vehicle (50), further comprising an inertial measurement unit (38) for determining movement information of the vehicle (50), with the control and evaluation unit (34, 64) being configured to compare the first speed value and the movement information with each other.

The invention relates to a safety system and a method for safeguarding the surrounding are of a vehicle.

Optoelectronic sensors are used to monitor the surrounding area of a vehicle in order to prevent accidents. A large field of application are driverless transport systems for example in logistics. The sensor detects when objects cross the vehicle's route in order to slow down or change the route of the vehicle in time if a collision with a person is imminent.

A particularly suitable sensor for this kind of application is a laser scanner. In a laser scanner, a light beam generated by a laser periodically scans a section of the surrounding area with the help of a deflection unit. The light is remitted at objects located in the surrounding area and evaluated in the laser scanner. The angular position of the deflection unit is used to determine the angular position of the object, and the light time of flight is used to determine the distance of the object from the laser scanner using the speed of light. With the angle and distance information, the location of an object in the monitoring area is detected in two-dimensional polar coordinates.

Sensors used in safety technology must work very reliable and therefore meet high safety requirements, for example the EN13849 standard for machine safety and the EN61496 standard for electro-sensitive protective equipment (ESPE). A series of measures must be taken to meet these safety standards, such as safe electronic evaluation through redundant, diverse electronics, function monitoring or monitoring of the contamination of optical components, in particular a front screen.

A laser scanner meeting these requirements is called a safety laser scanner and is, for example, known from DE 43 40 756 A1. A protective field is monitored in which no object or, in the case of more complex evaluation, no unexpected object is allowed. In the event of a forbidden intrusion into the protective field, a safety measure is initiated. Warning fields are often arranged in front of the protective fields, where intrusions merely lead to a warning, in order to timely prevent the protective field intrusion and thus the safety reaction, so that the availability of the vehicle and the associated system is increased.

Since the risk of collision when safeguarding a vehicle depends on speed, some conventional safety laser scanners offer the possibility of adapting or switching the protective field geometries. They also allow the connection of encoders that measure the rotational movement of the wheels and thus the position or speed of the vehicle. In this way, protective fields can be adapted to the vehicle speed to ensure that the braking distance always remains sufficient in the event of a protective field violation. This allows a more dynamic vehicle behavior and more efficient vehicle deployment.

However, in that case, the speed of the vehicle becomes a safety-relevant measured value and must be detected with a reliability matching the required safety level as defined by relevant standards, for example a performance level. One conceivable requirement is single-fault safety, which means that if a random fault occurs, the speed determination system continues to operate reliably or detects the fault and ensures that the vehicle enters a safe state.

Safety can be achieved by measuring the speed from two sources. In one variant, the non-safe speed signals of a connected encoder are combined with an optical speed determination from the time-varying distance measurement values of the safety laser scanner. The problem is that a suitable immovable object must be present in the field of view, such as a fixed wall, whose movement relative to the vehicle is converted into a speed. Therefore, there are too many scenarios wherein the optical speed determination is not sufficiently reliable or fails completely. These include translation-invariant surroundings, such as driving over extensive open spaces or a long corridor with smooth side walls, rotation-invariant surroundings, although less relevant, and large moving objects in the field of view, such as other vehicles whose speed is not known to the safety laser scanner and which are incorrectly assumed to be stationary or which occlude other stationary objects that would be suitable for speed determination.

In another variant, two independent encoders are used, which both transmit their signals to the safety laser scanner, where the difference between the measured speeds must then be within a specified tolerance. This provides for failsafe measurement by redundancy. A major disadvantage are the costs and the space required for the second encoder, which must be mechanically and electrically connected to the drive system in addition to the first encoder, thus causing difficulties in the design, especially in small vehicles. The safety laser scanner also requires two additional input terminals for safe, two-channel transmission of the signals from the second encoder. Even if all of this is accepted, only errors that are due to the exceeding of the specified tolerance thresholds of the difference value, including the failure of one of the encoders, can be detected in this way. However, undetectable errors remain, in particular when both encoders measure a zero value.

From EP 2 302 416 A1, a vehicle safeguarding by means of a safety laser scanner with speed-dependent protective fields adaption is known. The safety of the speed detection is achieved in that the safety laser scanner receives and compares target speed signals from the vehicle control system in addition to the signals of an encoder. However, the target speed is not always a reliable comparison value, and moreover, suitable interfaces must be created in the vehicle control system, which are regularly not accessible for such a functional extension.

It is therefore an object of the invention to enable reliable speed detection without these disadvantages.

This object is satisfied by a safety system for safeguarding a surrounding area of a vehicle, wherein the safety system comprises an optoelectronic safety sensor for monitoring the surrounding area, a first input connectable to a first kinematic sensor for determining a first speed value for the speed of the vehicle, and a control and evaluation unit configured to detect objects in the surrounding area based on sensor data of the optoelectronic safety sensor and to evaluate whether or not the vehicle initiates a safety reaction, taking into account the speed of the vehicle, further comprising an inertial measurement unit for determining movement information of the vehicle, with the control and evaluation unit being configured to compare the first speed value and the movement information with each other.

The object is also satisfied by a method for safeguarding a surrounding area of a vehicle, wherein the surrounding area is monitored by an optoelectronic safety sensor, a first speed value for the speed of the vehicle is determined by means of a first kinematic sensor, objects in the surrounding area are detected by means of sensor data of the safety sensor and it is evaluated, taking into account the speed of the vehicle, whether or not the vehicle initiates a safety reaction, wherein movement information of the vehicle is determined by means of an inertial measuring unit and the first speed value and the movement information are compared with each other.

The vehicle is in particular an automated guided vehicle (AGV, or AGC, automated guided container). The vehicle's surrounding area is optically monitored by a safety sensor. The terms safety and safe are used throughout the entire specification to mean fault safety or fault detection in the sense of the relevant standards. An input of the safety system receives a signal from a first kinematic sensor, which allows a first speed value to be determined for the speed of the monitored vehicle. The first kinematic sensor provides a speed signal or alternatively a signal from which the speed can be determined, such as a position or a distance travelled.

A control and evaluation unit uses the sensor data from the safety sensor to detect objects in the surrounding area and evaluates whether one of the detected objects causes a danger. In the event of an imminent danger, a safety-related reaction is initiated, preferably via the vehicle control system, such as emergency braking, evasive action or a reduction in speed. In this danger assessment, the speed of the vehicle is taken into account. For example, if there is a far object in the path of travel, the vehicle has to brake at high speed, but not at low speed, where it has to brake only at a later time if the far object becomes a near object in the path of travel. Depending on the embodiment, the control and evaluation unit is either integrated into the safety sensor, implemented in a safety control connected to the safety sensor, or various subfunctions are distributed over both components.

The invention starts from the basic idea of additionally using an inertial measurement unit (IMU, Inertial Sensor) in order to test or validate the measurement of the speed of the vehicle by the first kinematic sensor with its movement information. This plausibility test of the first speed value of the first kinematic sensor with the movement information of the inertial measurement unit results in a safe speed detection. Obviously, no direct comparison of the different physical quantities is possible; the inertial measuring unit initially measures acceleration and not speed. Nevertheless, an expectation for the acceleration can be derived from the first speed value or its history, or conversely, an expectation for the speed can be derived from the acceleration. The detection of an error in the determination of speed results in a safety-related reaction, which may be associated with an indication of the cause. Alternatively, if the speed determination is no longer reliable, worst-case assumptions may be used, such as a maximum vehicle speed.

The first speed value of the first kinematic sensor is preferably used for the danger assessment, and the movement information is only an auxiliary value so that the speed detection becomes safe. However, it is also conceivable to integrate accelerations, for example, thus to determine the speed by means of the inertial measuring unit and to use this value for further evaluation, or to combine the speed information of both sources. Throughout this specification, the terms preferably or preferred relate to advantageous, but completely optional features.

The invention has the advantage that the speed is measured in a safe way even in the unfavorable scenarios described in the introduction. Two redundant encoders or communication with the vehicle control system for additional speed information are no longer necessary. Should such sources still be used, an even higher safety level can be achieved. Numerous fault scenarios can be detected, including a blocked or partially blocked wheel.

The control and evaluation unit preferably is configured to determine a second speed value for the speed of the vehicle from the sensor data of the safety sensor by means of optical speed estimation. A second speed measurement increases the safety level. Various methods are conceivable for optical speed estimation, such as optical flow, SLAM methods (Simultaneous Localization and Mapping) for navigation and thus repeated self-localization, or optical measurement of the distance to surrounding objects and evaluation of the change in distance to fixed objects over time. The second speed value is detected on the basis of evaluations alone, without additional sensors and connections.

The safety system preferably comprises a second input that can be connected to a second kinematic sensor for determining a second speed value for the speed of the vehicle. In this embodiment, an additional sensor is used instead of an optical speed estimation. In principle, two kinematic sensors could also be combined with an optical speed estimation and an inertial measuring unit. However, that many sources are not required for usual safety levels, and thus the costs required are usually not justified.

The first kinematic sensor preferably is a rotary encoder which is connected at least indirectly to a vehicle axle of the vehicle, as is the second kinematic sensor, if present. The path or speed information is thus derived from the rotation of the wheels of the vehicle.

The control and evaluation unit preferably is configured to compare the first speed value and the second speed value and/or the second speed value and the movement information with each other. The optical speed estimation or the second kinematic sensor provides a second speed value. The two speed values can be compared with each other, for example whether their difference lies within a tolerance interval, or the plausibility of the second speed value is tested for plausibility based on the movement information of the inertial measuring unit, or both.

The control and evaluation unit preferably is configured to determine the speed of the vehicle in a safe manner by means of the first kinematic sensor, an optical speed estimation from the sensor data of the safety sensor and the movement information of the inertial measuring unit. This once again summarizes features that already have been mentioned. In this embodiment, there is a three-fold diverse redundancy of first kinematic sensor, inertial measuring unit and optical speed estimation. Costs are saved by not requiring a second encoder path on the vehicle.

The control and evaluation unit preferably is configured to determine the speed of the vehicle in a safe manner by means of the first kinematic sensor, the second kinematic sensor and the movement information of the inertial measuring unit. This is another embodiment based on features that already have been mentioned. There is a redundant detection with two kinematic sensors and an additional diverse redundancy in the form of the inertial measuring unit.

The control and evaluation unit preferably is configured to test, in the case of a standstill value of the first speed value and the second speed value, whether the movement information is compatible with a standstill of the vehicle. An incorrectly assumed standstill is an exceptionally critical situation. If the first and second speed values indicate a standstill, in particular if both kinematic sensors output the value zero with a certain tolerance, then the movement information of the inertial measurement unit must be compatible with a standstill of the vehicle.

In order to be compatible with a standstill of the vehicle, the movement information preferably has to indicate no movement if the standstill values are present over a time interval and/or has to indicate a matching braking acceleration if the first speed value and the second speed value decrease to the standstill values. Hence, two cases are distinguished for standstill monitoring. Firstly, both speed values can indicate a standstill for a certain time. In that case, the vehicle must be at rest, and accordingly the inertial measurement unit must not measure any acceleration. On the other hand, the speed values can also drop to the standstill value. In that case, the inertial measurement unit is expected to measure an acceleration corresponding to a deceleration from the last measured speed. If the respective expectation for the measurement of the inertial measurement unit is not met, an error is detected.

The inertial measuring unit and/or the control and evaluation unit preferably is integrated into the safety sensor. An inertial measuring unit in the safety sensor has the advantage that no connections are required, unlike a kinematic sensor which monitors vehicle axles. The inertial measuring unit is thus also located in the safe environment of the safety sensor, so that this safety-relevant functionality is encapsulated against the outside. For similar reasons, it is advantageous to accommodate the control and evaluation unit in the safety sensor. However, at least part of it can be implemented in a safety control connected to the safety sensor.

The safety sensor preferably is configured as a safety laser scanner comprising a light transmitter for transmitting a light beam, a rotatable deflection unit for periodically deflecting the light beam in the surrounding area, an angle measuring unit for determining an angular position of the deflection unit, and a light receiver for generating a reception signal from the light beam remitted or reflected by objects in the surrounding area, wherein the control and evaluation unit is configured to determine a light time of flight to the objects respectively scanned with the light beam based on the reception signal. In particular, the control and evaluation unit is configured to monitor at least one protective field, adapted in dependence on a speed information, for object intrusion in order to determine whether or not the vehicle initiates a safety reaction. Depending on its design, the deflection unit can be a rotating mirror or a rotating scanning head wherein light transmitters and/or light receivers are accommodated. If the deflection unit is additionally tilted or a plurality of scanning beams are spaced in elevation, the monitored surrounding area is expanded from a plane to a three-dimensional spatial area. In case that part of the control and evaluation unit is implemented in a connected safety control, preferably at least the time-of-flight measurement or also the protective field evaluation is performed in the safety laser scanner. The safety control unit may be responsible, for example, for the safe speed detection and the adaption or switching of the protective fields.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

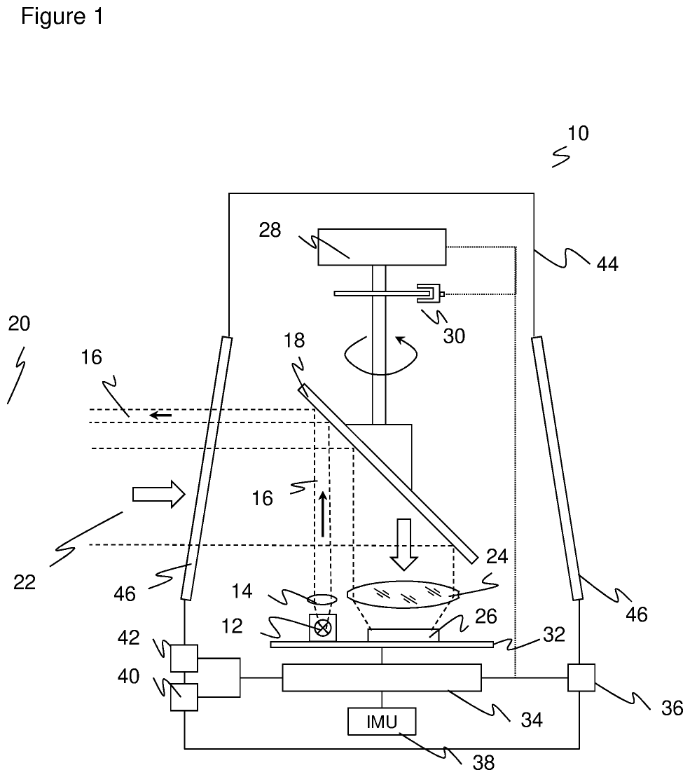

FIG. 1 a schematic sectional view of a safety laser scanner with an inertial measuring unit;

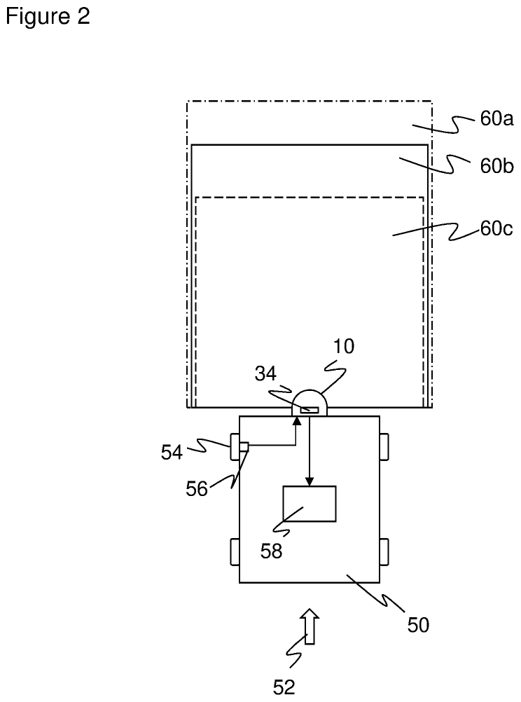

FIG. 2 a schematic representation of a vehicle safeguarded by an optoelectronic safety sensor and safe speed determination by an encoder and optical speed estimation;

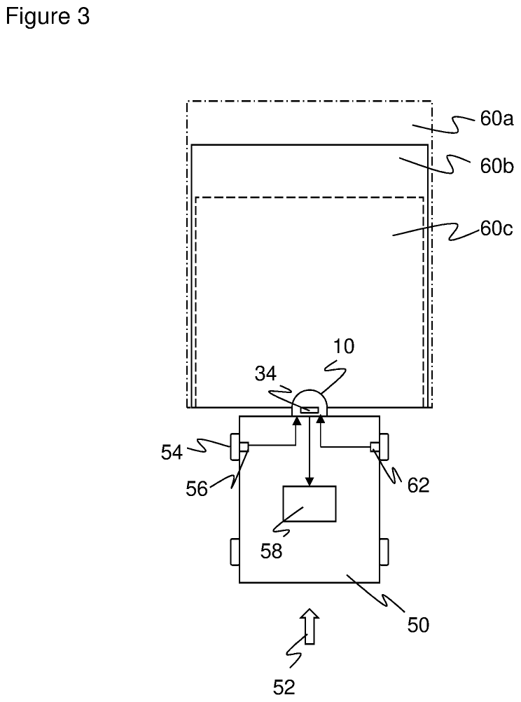

FIG. 3 a schematic representation of a vehicle similar to FIG. 2, but with speed determination by two rotary encoders;

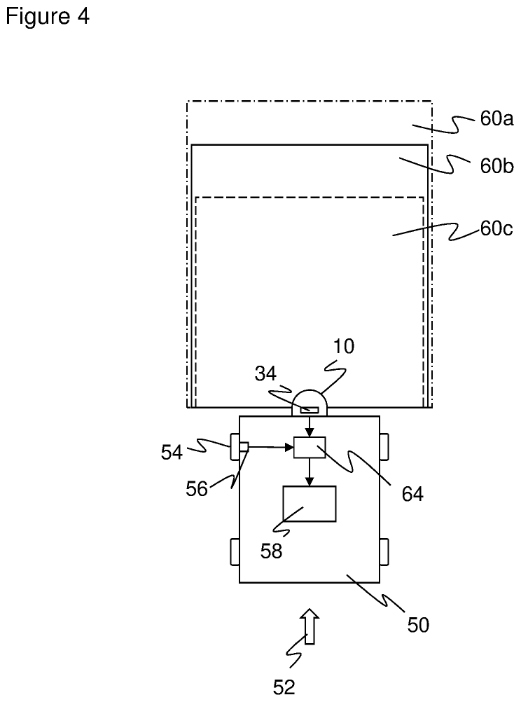

FIG. 4 a schematic representation of a vehicle similar to FIG. 2, but with at least some of the evaluations in a safety control; and

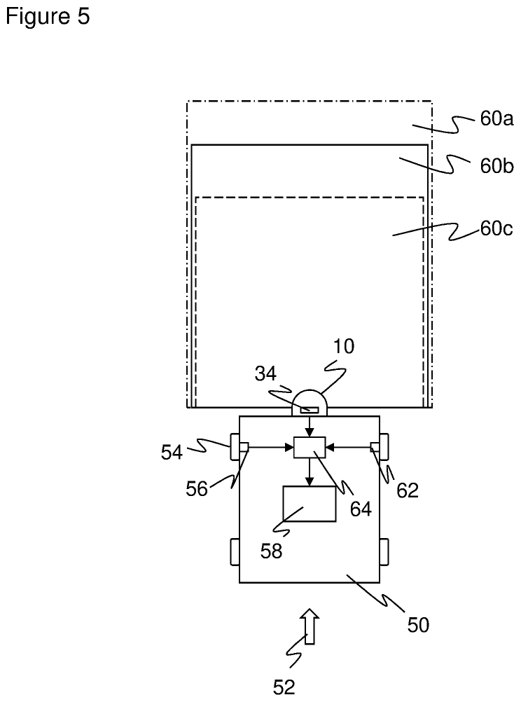

FIG. 5 a schematic representation of a vehicle similar to FIG. 3, but with at least some of the evaluations in a safety control.

FIG. 1 shows a schematic sectional view of a safety laser scanner 10 that can be used for safeguarding a vehicle, as explained below with reference to FIGS. 2 to 5.

In the safety laser scanner 10, a light transmitter 12, for example with a laser light source in the infrared or another spectral range, generates a transmitted light beam 16 by means of transmission optics 14, which is deflected at a deflection unit 18 into a monitoring area 20. If the transmitted light beam 16 impinges on an object in the monitoring area 20, remitted light 22 returns to the safety laser scanner 10 and is detected via the deflection unit 18 and receiving optics 24 by a light receiver 26, for example a photodiode or an APD (Avalanche Photo Diode).

The deflection unit 18 in this embodiment is configured as a rotating mirror and rotates continuously driven by a motor 28. Alternatively, a measuring head including light transmitter 12 and light receiver 26 may rotate. The respective angular position of the motor 28 or the deflection unit 18 is detected by an angle measuring unit 30, for example in the form of a code disk rotating with the motor 28 and a forked photoelectric sensor.

The transmitted light beam 16 generated by the light transmitter 12 thus sweeps over the monitoring area 20 generated by the rotational movement. The design of transmission optics 14 and receiving optics 24 can be varied, for example by using a beam-shaping mirror as a deflection unit, by a different arrangement of lenses or by additional lenses. In particular, laser scanners are also known in an auto-collimation arrangement. In the embodiment shown, light transmitter 12 and light receiver 26 are accommodated on a common circuit board 32. This, too, is only an example, as separate circuit boards as well as other arrangements, for example with a mutual height offset, can be provided.

If remitted light 22 from the monitoring area 20 is received by the light receiver 26, the angular position of the deflection unit 18 measured by the angle measuring unit 30 can be used to determine the angular position of the object in the monitoring area 20. In addition, the light time of flight from transmission of a light signal to its reception after reflection at the object in the monitoring area 20 preferably is determined, for example with a pulse or phase method, and the distance of the object from the safety laser scanner 10 is determined using the speed of light.

This evaluation takes place in a control and evaluation unit 34 which is connected to the light transmitter 12, the light receiver 26, the motor 28 and the angle measuring unit 30. Thus, two-dimensional polar coordinates of all objects in monitoring area 20 are available via the angle and distance. The control and evaluation unit 34 evaluates whether a forbidden object intrudes into at least one protective field defined within monitoring area 20. If this is the case, a safety signal is output via a safety output 36 (OSSD, Output Signal Switching Device). The safety laser scanner 10 is of safe design due to measures in accordance with the standards mentioned in the introduction.

The safety laser scanner 10 furthermore includes an inertial measuring unit 38. This can be an integrated MEMS device, for example. The inertial measuring unit 38 determines the acceleration, preferably in all three spatial directions, and the angular speed with respect to all three axes. If the mounting position of the safety laser scanner 10 on a vehicle is known, fewer degrees of freedom may also be sufficient, for example for measuring the acceleration only in the direction of travel.

The safety laser scanner 10 has one input 40 or two inputs 40, 42 for connecting one or two sensors for speed measurement. The speed of a vehicle where the safety laser scanner 10 is mounted which is detected via these inputs is verified in a manner yet to be described and thus becomes safe information in the sense of the standards mentioned in the introduction using some or all of the following information: the speeds obtained via the two inputs, the acceleration information of the inertial measuring unit 38 and an optical speed estimation from the measurement data of the safety laser scanner. The protective fields can then be adapted to the current speed.

All the above-mentioned functional components of the safety laser scanner 10 are arranged in a housing 44, which has a front window 46 in the area of the light exit and light entry.

FIG. 2 shows a schematic representation of a vehicle 50, in particular an automated guided vehicle (AGV), where at least one safety laser scanner 10 is mounted to safeguard the movement paths. If the vehicle 50 is moving in one direction 52 only, a front safety laser scanner 10 is sufficient, otherwise additional safety laser scanners 10 are possible, for example on the rear, to safeguard the surrounding area when moving backwards. Instead of a safety laser scanner 10, other optoelectronic safety sensors can also be used, such as a camera, especially a 3D camera based on the time-off-light principle or a stereo camera.

The vehicle 50 moves on wheels 54, with an encoder 56 measuring the rotation rate of one of the wheels 54 to determine the speed of the vehicle 50 and transmitting this information to the safety laser scanner 10 via a connection to the safety laser scanner's corresponding input 40, 42. A vehicle controller 58 controls the vehicle 50, i.e. determines its accelerations, steering angles, speeds and the like. Preferably, the safety output 36 of the safety laser scanner 10 is connected to the vehicle control unit 58 in order to initiate a safety-related reaction of the vehicle 50 when a danger is detected.

The rotary encoder 56 and its connection to the safety laser scanner 10 and also the inputs 40, 42 are preferably single-channel or non-safe. The reliability of the speed measurement is increased by means of the inertial measuring unit 38. Thus, independent of the surroundings of the safety laser scanner 10, at least a rough estimate of the change in speed and quite an exact estimate of the change in rotation can be measured. Based on the speed measured with the rotary encoder 56 and possibly a stored movement history of the safety laser scanner 10, the control and evaluation unit 34 can calculate an expectation for the signals of the inertial measuring unit 38, i.e. its angular speed and linear acceleration in all required axes. This is compared with the actual output signal of the inertial measuring unit 38. If there is a sufficient match, the measured speed is considered to be safe. Conversely, the accelerations from the inertial measuring unit 38 can also be integrated and compared with the speed determined by the encoder 56.

The inertial measuring unit 38 preferably is only used for plausibility tests, because at least in a low-cost version, which is particularly suitable for integration in a safety laser scanner 10, it may be too inaccurate for the actual speed measurement. Therefore, the speed can preferably be measured with an additional source. An additional encoder for this purpose will be discussed later with reference to FIG. 3. However, still with reference to FIG. 2, it is also possible to optically estimate the movement of the safety laser scanner 10 from its distance measurement data. Various algorithms are conceivable, such as SLAM (Simultaneous Location and Mapping) or optical flow. A method that evaluates the measured distances from successive scans that change over time is particularly suitable. The quality of the estimation depends on the properties of the surroundings. It is usually of high accuracy, but can also become unreliable in some cases, such as in the scenarios mentioned in the introduction with long corridors or large moving objects in the field of view.

On the one hand, assuming a rigidly mounted wheel 54 and known fixed positional relationship to the installation position of the safety laser scanners 10, it is continuously tested whether the value output by the encoder is compatible with the speed calculated by the optical motion estimation. For this purpose, depending on the application, information on the current curve radius or, in the case of a rotating wheel, the steering angle may also be required from the vehicle control unit 58.

On the other hand, this speed measurement, which has already been confirmed from two sources, is also tested via the inertial measurement unit 38 as described. This means that a safe speed value can be determined with a single encoder 56, without a redundant second encoder. As long as the speed measured with the rotary encoder 56 is compatible with the signal of the inertial measuring unit 38, it is even conceivable that short-term discrepancies between the speed measured with the rotary encoder 56 and the speed optically estimated from the measurement data of the safety laser scanner or short failure phases of the optical motion estimation can be compensated.

A special case is the standstill of vehicle 50, which should be detected with particular reliability because no danger emanates from a stationary vehicle 50, and therefore all the more so from a vehicle 50 which is incorrectly detected as stationary. Two cases can arise. On the one hand, both the encoder 56 and the optical speed estimator can permanently, i.e. for at least a certain period of time, output a standstill value of “zero”. In that case, the inertial measuring unit 38 must not output any significant acceleration, otherwise there is an error. On the other hand, the measured or estimated speed can drop to the standstill value “zero”. In this case, the inertial measurement unit 38 must measure an acceleration corresponding to this change in speed or this braking period, otherwise there is an error.

After the measures described above, the control and evaluation unit 34 knows the current speed of the vehicle 50 in a safe way. Depending on this, one of several configurations of protective fields 60a-c is selected and activated, or alternatively a configuration with protective fields 60a-c is determined dynamically, taking into account the current speed and possibly further parameters such as the direction of travel. For example, at high speed a long braking distance is safeguarded with a large protective field 60a, which at low speeds could trigger unnecessary safety measures and is therefore replaced by a short protective field 60c.

If a forbidden object is detected in an active protective field 60a-c during movement of the vehicle 50, a safety signal is output to vehicle control unit 58 to prevent collisions, primarily with persons, but also with other objects such as other vehicles, which can initiate an emergency stop, a braking maneuver or an evasive maneuver or at first just reduce the speed.

A safety signal is also output if an error is detected in the speed determination, i.e. the speed measured with the encoder 56 deviates too far from the optical speed estimation and/or is not compatible with the signal of the inertial measuring unit 38. It is conceivable to tolerate such inconsistencies for a predetermined, limited period of time in order to avoid triggering an emergency stop at every jerk in motion. Furthermore, it is also conceivable to respond to a speed determination detected as faulty with worst-case assumptions instead of a safety-related reaction. This means, for example, that a maximum speed of the vehicle 50 is assumed or, as a precaution, a switchover to the most generous protective fields 60a is made. A further measure for higher availability is not to stop a vehicle 50 completely, but to limit its movement to a safe speed (“creep speed”).

FIG. 3 again shows a vehicle 50 whose movement is safeguarded by a safety laser scanner 10. In contrast to FIG. 2, a second encoder 62 is now provided, which is connected to an input 40, 42 of the safety laser scanner 10, so that the speed is detected redundantly with two encoders 56, 62. The second rotary encoder 62 thus functionally replaces the optical motion estimation in the embodiment described with reference to FIG. 2. It is conceivable to add the optical motion estimation, so that there is a further source for speed determination.

The mode of operation of this embodiment is analogous to that shown in FIG. 2 and is not described again. To ensure safe speed detection, it is required that the two speeds measured by the encoders 56, 62 correspond to one another within the scope of specified tolerances. In addition to the redundant detection with the two rotary encoders 56, 62, a further type of motion detection is provided by the inertial measuring unit 38 integrated in the safety laser scanner 10.

In particular, a simultaneous failure of both encoders 56, 62 can be detected by a standstill monitoring, i.e. it can be tested whether the two encoders 56, 62 are generating valid signals. This test is performed on the basis of two logical conditions: If the outputs of both encoders 56, 62 drop to the standstill value “zero”, the inertial measuring unit 38 must detect a corresponding acceleration. If the outputs of both encoders 56, 62 permanently, i.e. for longer than a short time interval, output the standstill value “zero”, the inertial measuring unit 38 must not output any significant acceleration. If one of the conditions is violated, there is an error.

FIGS. 4 and 5 again show a vehicle 50 to explain further embodiments. FIG. 4 is based on FIG. 2 with optical motion estimation and FIG. 5 on FIG. 3 with two rotary encoders 56, 62. So far it has been assumed that the inertial measuring unit 38 and the control and evaluation unit 34 are part of the safety laser scanner 10. This is also the preferred embodiment.

Alternatively, however, it is conceivable to move at least part of the control and evaluation functionality to a safety control 64 that is connected to the safety laser scanner 10 and the encoder 56 or the encoders 56, 62. A preferred distribution of tasks is that the control and evaluation unit 34 in the safety laser scanner 10 is responsible for the time-of-flight measurement and the protective field monitoring, while the safety control evaluates and tests the speeds and outputs signals to the safety laser scanner 10 for activating protective fields 60a-c adapted to the speed. It is furthermore conceivable to provide the inertial measuring unit 38 externally, i.e. outside the safety laser scanner 10, and to connect it to the safety laser scanner 10 or the safety control 64.

1. A safety system (10, 64) for safeguarding a surrounding area of a vehicle (50), wherein the safety system (10, 64) comprises an optoelectronic safety sensor (10) for monitoring the surrounding area, a first input (40) connectable to a first kinematic sensor (56) for determining a first speed value for the speed of the vehicle (50), and a control and evaluation unit (34, 64) configured to detect objects in the surrounding area based on sensor data of the optoelectronic safety sensor (10) and to evaluate whether or not the vehicle (50) initiates a safety reaction, taking into account the speed of the vehicle (50),
further comprising an inertial measurement unit (38) for determining movement information of the vehicle (50), with the control and evaluation unit (34, 64) being configured to compare the first speed value and the movement information with each other.

2. The safety system (10, 64) according to claim 1,
wherein the vehicle (50) is a driverless vehicle.

3. The safety system (10, 64) according to claim 1,
wherein the control and evaluation unit (34, 64) is configured to determine a second speed value for the speed of the vehicle (50) from the sensor data of the safety sensor (10) by means of optical speed estimation.

4. The safety system (10, 64) according to claim 3,
wherein the control and evaluation unit (34, 64) is configured to compare the first speed value and the second speed value with each other.

5. The safety system (10, 64) according to claim 3,
wherein the control and evaluation unit (34, 64) is configured to compare the second speed value and the movement information with each other.

6. The safety system (10,64) according to claim 3,
wherein the control and evaluation unit (34, 64) is configured to test, in the case of a standstill value of the first speed value and the second speed value, whether the movement information is compatible with a standstill of the vehicle (50).

7. The safety system (10,64) according to claim 6,
wherein, in order to be compatible with a standstill of the vehicle, the movement information has to indicate no movement if the standstill values are present over a time interval, and/or has to indicate a matching braking acceleration if the first speed value and the second speed value decrease to the standstill values.

8. The safety system (10, 64) according to claim 1,
comprising a second input (42) that can be connected to a second kinematic sensor (62) for determining a second speed value for the speed of the vehicle (50).

9. The safety system (10, 64) according to claim 8,
wherein at least one of the first kinematic sensor (56) and the second kinematic sensor (62) is a rotary encoder which is connected at least indirectly to a vehicle axle of the vehicle (50).

10. The safety system (10, 64) according to claim 8,
wherein the control and evaluation unit (34, 64) is configured to compare the first speed value and the second speed value with each other.

11. The safety system (10, 64) according to claim 8,
wherein the control and evaluation unit (34, 64) is configured to compare the second speed value and the movement information with each other.

12. The safety system (10, 64) according to claim 1,
wherein the control and evaluation unit (34, 64) is configured to determine the speed of the vehicle (50) in a safe manner by means of the first kinematic sensor (56), an optical speed estimation from the sensor data of the safety sensor (10) and the movement information of the inertial measuring unit (38).

13. The safety system (10, 64) according to claim 8,
wherein the control and evaluation unit (34, 64) is configured to determine the speed of the vehicle (50) in a safe manner by means of the first kinematic sensor (56), the second kinematic sensor (62) and the movement information of the inertial measuring unit (38).

14. The safety system (10, 64) according to claim 8,
wherein the control and evaluation unit (34, 64) is configured to test, in the case of a standstill value of the first speed value and the second speed value, whether the movement information is compatible with a standstill of the vehicle (50).

15. The safety system (10, 64) according to claim 14,
wherein, in order to be compatible with a standstill of the vehicle, the movement information has to indicate no movement if the standstill values are present over a time interval, and/or has to indicate a matching braking acceleration if the first speed value and the second speed value decrease to the standstill values.

16. The safety system (10, 64) according to claim 1,
wherein at least one of the inertial measuring unit (38) and the control and evaluation unit (34) is integrated into the safety sensor (10).

17. The safety system (10, 64) according to claim 1,
wherein the safety sensor (10) is configured as a safety laser scanner comprising a light transmitter (12) for transmitting a light beam (16), a rotatable deflection unit (18) for periodically deflecting the light beam (16) in the surrounding area (20), an angle measuring unit (30) for determining an angular position of the deflection unit (18), and a light receiver (26) for generating a reception signal from the light beam (22) remitted or reflected by objects in the surrounding area (20), wherein the control and evaluation unit (34) is configured to determine a light time of flight to the objects respectively scanned with the light beam based on the reception signal.

18. The safety system (10, 64) according to claim 17,
wherein the control and evaluation unit (34) is configured to monitor at least one protective field (60a-c), adapted in dependence on a speed information, for object intrusion in order to determine whether or not the vehicle (50) initiates a safety reaction.

19. A method for safeguarding a surrounding area of a vehicle (50), wherein the surrounding area is monitored by an optoelectronic safety sensor (10), a first speed value for the speed of the vehicle (50) is determined by means of a first kinematic sensor (56), objects in the surrounding area are detected by means of sensor data of the safety sensor (10) and it is evaluated, taking into account the speed of the vehicle (50), whether or not the vehicle (50) initiates a safety reaction,
wherein movement information of the vehicle (50) is determined by means of an inertial measuring unit (38) and the first speed value and the movement information are compared with each other.

20. The method according to claim 19,
wherein the vehicle (50) is a driverless vehicle.
